(19) United States
(12) Patent Application Publication
(10) Pub. No.: US 2026/0038972 A1
(43) Pub. Date: Feb. 5, 2026

(54) SECONDARY BATTERY AND METHOD OF MANUFACTURING SAME

(71) Applicant: SAMSUNG SDI CO., LTD., Yongin-si (KR)

(72) Inventor: Jiwon YUN, Yongin-si (KR)

(21) Appl. No.: 19/008,851

(22) Filed: Jan. 3, 2025

(30) Foreign Application Priority Data
Aug. 5, 2024 (KR) 10-2024-0103954

(51) Int. Cl. H01M 50/474; H01M 50/109; H01M 50/153; H01M 50/548

(52) U.S. Cl. CPC H01M 50/474; H01M 50/109; H01M 50/153; H01M 50/548

(57) ABSTRACT

A secondary battery includes an electrode assembly including a first electrode and a second electrode, a case including a first side that is open, the case accommodating the electrode assembly and being electrically connected to the second electrode, a cap assembly coupled to the first side of the case, the cap assembly being electrically connected to the first electrode, and a spacer coupled to an outer portion of the case and contacting the cap assembly, the spacer including a first protrusion and a second protrusion opposite the first protrusion, the first protrusion and the second protrusion contacting the case.

### CROSS REFERENCE TO RELATED APPLICATION

The present application claims priority to and the benefit of Korean Application No. 10-2024-0103954, filed on Aug. 5, 2024, in the Korean Intellectual Property Office, the entire disclosure of which is incorporated by reference herein.

### BACKGROUND

### 1. Field

The present disclosure relates to a secondary battery and a method of manufacturing the same.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The above information disclosed in this Background section is for enhancement of understanding of the background of the present disclosure, and therefore, it may contain information that does not constitute related (or prior) art.

### SUMMARY

Aspects of embodiments provide a secondary battery including an electrode assembly having a first electrode and a second electrode, a case including a first side that is opened, the case configured to accommodate the electrode assembly, and electrically connected to the second electrode, a cap assembly coupled to the open first side of the case, and electrically connected to the first electrode, and a spacer coupled to an outer portion of the case and contacting the cap assembly, the spacer including a first protrusion configured to contact the case and a second protrusion provided at a position opposite the first protrusion.

According to embodiments of the present disclosure, the spacer may include a terminal opening configured to expose at least a portion of the cap assembly, and an insertion opening into which portions of the cap assembly and the case are inserted, and each of the first protrusion and the second protrusion protrudes from an inner circumferential surface of the spacer.

According to embodiments of the present disclosure, a region between the first protrusion and the second protrusion may have a first diameter, and the case may have a cylindrical shape having an outer circumferential surface having a second diameter greater than the first diameter.

According to embodiments of the present disclosure, the insertion opening of the spacer may have a third diameter greater than the second diameter.

According to embodiments of the present disclosure, each of the first protrusion and the second protrusion may be provided in a plurality, the plurality of first protrusions may be spaced part from each other by a predetermined gap, and the plurality of second protrusions may be spaced part from each other by a predetermined gap.

According to embodiments of the present disclosure, each of the first protrusion and the second protrusion may include a straight portion in surface contact with the case.

According to embodiments of the present disclosure, the spacer may include an elastic material.

According to embodiments of the present disclosure, while the spacer is coupled to an outer portion of the case, the first protrusion and the second protrusion may be elastically deformed in a direction away from each other.

According to embodiments of the present disclosure, in a state where the spacer is coupled to the outer portion of the case, the first protrusion and the second protrusion may press the case.

According to embodiments of the present disclosure, the cap assembly may include a terminal plate including a disk-shaped body portion and an insertion portion protruding from the body portion, and the diameter of the terminal opening may be greater than a diameter of the body.

Aspects of embodiments also provide a secondary battery including an electrode assembly having a first electrode and a second electrode, a cylindrical case including a first side that is opened to accommodate the electrode assembly and electrically connected to the second electrode, a cap assembly coupled to the first side of the case and including a terminal plate electrically connected to the first electrode, and a spacer including a first protrusion configured to contact an outer portion of the case and a second protrusion provided at a position opposite the first protrusion, the spacer contacting the cap assembly, wherein while the spacer is coupled to the outer portion of the case, the first protrusion and the second protrusion are elastically deformed in a direction away from each other, and in a state where the spacer is coupled to the outer portion of the case, the first protrusion and the second protrusion press the case in a direction toward each other.

According to embodiments of the present disclosure, the first protrusion and the second protrusion may protrude from an inner circumferential surface of the spacer in a direction facing each other.

According to embodiments of the present disclosure, the spacer may include a terminal opening configured to expose at least a portion of the cap assembly, and an insertion opening defined by the coupling portion so that a portion of the case is inserted, a portion of the terminal plate may be positioned inside the terminal opening.

According to embodiments of the present disclosure, a region between the first protrusion and the second protrusion may have a first diameter, an outer circumferential surface of the case may have a second diameter greater than the first diameter, and the insertion opening of the spacer may have a third diameter greater than the second diameter.

Aspects of embodiments also provide a method of manufacturing a secondary battery including mounting a case on a lower jig, the case having an electrode assembly and a cap assembly accommodated therein, seating a spacer on an outer portion of the case, and pressing the spacer so that the spacer is interference-fitted into the case with the cap assembly closely contacting the case.

According to embodiments of the present disclosure, the operation of pressing the spacer may include pressing the spacer using a first pressing jig until the pressing portion of the spacer and the cap assembly have a predetermined gap, and pressing a portion of the pressing portion of the spacer using a second pressing jig until the spacer is mounted on an upper portion of the case.

According to embodiments of the present disclosure, the operation of pressing the spacer may include pressing the spacer until the pressing portion of the spacer and an upper surface of the cap assembly have a gap of 0.5 mm to 2.0 mm.

According to embodiments of the present disclosure, the spacer may include a pressing portion including a terminal opening and the pressing portion mounted on an upper portion of the case, a coupling portion extending perpendicularly from an outer end of the pressing portion, and a protrusion protruding from an inner circumferential surface of the coupling portion and contacting the case.

According to embodiments of the present disclosure, the operation of pressing the spacer may include pressing the pressing portion into close contact with the cap assembly so that a portion of the cap assembly is positioned inside the terminal opening.

According to embodiments of the present disclosure, while the spacer is coupled to an outer portion of the case, a first protrusion and a second protrusion may be elastically deformed in a direction away from each other.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 illustrates a perspective view showing a secondary battery according to embodiments of the present disclosure.

FIG. 2 illustrates an exploded perspective view showing a secondary battery according to embodiments of the present disclosure.

FIG. 3 illustrates a cross-sectional view showing a secondary battery according to embodiments of the present disclosure.

FIG. 4 illustrates a bottom view showing a spacer according to embodiments of the present disclosure.

FIG. 5 illustrates a cross-sectional view showing a spacer according to embodiments of the present disclosure.

FIG. 6 illustrates an exploded cross-sectional view showing a secondary battery according to embodiments of the present disclosure.

FIG. 7 illustrates a cross-sectional view showing an example of a method of manufacturing a secondary battery according to embodiments.

FIG. 8 illustrates a cross-sectional view showing an example state pressed by a first pressing jig in a method of manufacturing a secondary battery according to embodiments.

FIG. 9 illustrates a deformed protrusion in a method of manufacturing a secondary battery according to embodiments.

FIGS. 10 and 11 illustrate cross-sectional views showing an example state pressed by a second pressing jig in a method of manufacturing a secondary battery according to embodiments.

FIG. 12 illustrates a flowchart of a method of manufacturing a secondary battery according to embodiments.

FIGS. 13 and 14 illustrate bottom views showing spacers of a secondary battery according to embodiments of the present disclosure.

FIG. 15 illustrates a cross-sectional view showing a spacer according to embodiments of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C,” “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “includes,” and/or “including,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

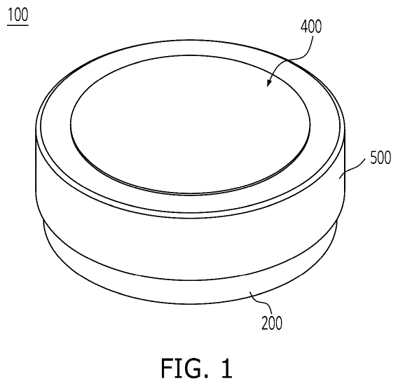

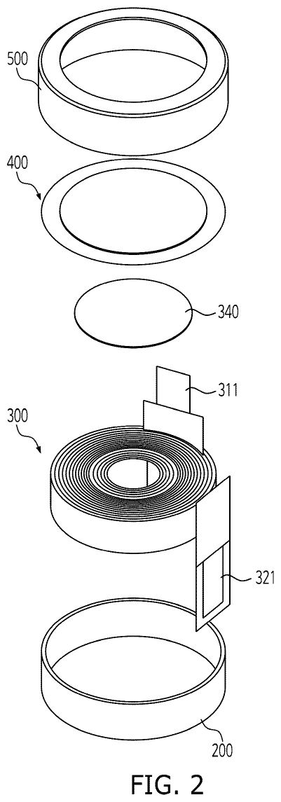

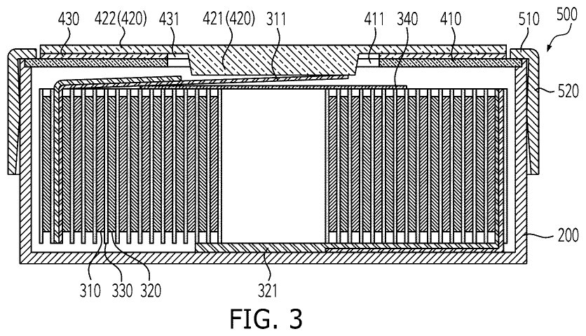

FIG. 1 illustrates a perspective view showing a secondary battery according to embodiments of the present disclosure. FIG. 2 illustrates an exploded perspective view showing the secondary battery according to embodiments of the present disclosure. FIG. 3 illustrates a cross-sectional view showing the secondary battery according to embodiments of the present disclosure.

Referring to FIGS. 1 to 3, a secondary battery 100 according to embodiments of the present disclosure may include an electrode assembly 300 having a first electrode 310, a separator 330, and a second electrode 320, a case 200 accommodating the electrode assembly 300 and electrically connected to the second electrode 320, a cap assembly 400 closing an open first side of the case 200 and electrically connected to the first electrode 310, and a spacer 500 provided with a terminal opening 511 and coupled to an outer portion of the case 200.

The electrode assembly 300 may include the separator 330 and the first electrode 310 and the second electrode 320 positioned with the separator 330 interposed therebetween and may be wound in a jelly-roll shape.

The first electrode 310 includes a first substrate and a first active material layer on the first substrate. A first lead tab 311 may extend outwardly from a first uncoated portion of the first substrate at where the first active material layer is not located, and the first lead tab 311 may be electrically connected to the cap assembly 400.

The second electrode 320 includes a second substrate and a second active material layer on the second substrate. A second lead tab 321 may extend outwardly from a second uncoated portion of the second substrate at where the second active material layer is not located, and the second lead tab 321 may be electrically connected to the case 200. The first lead tab 311 and the second lead tab 321 may extend in opposite directions.

The first electrode 310 may act as a positive electrode. In such an embodiment, the first substrate may be made of, for example, an aluminum foil, and the first active material layer may include, for example, a transition metal oxide. The second electrode 320 may act as a negative electrode. In such an embodiment, the second substrate may be made of, for example, a copper foil or a nickel foil, and the second active material layer may include graphite, for example.

The separator 330 prevents a short circuit between the first electrode 310 and the second electrode 320 while allowing movement of lithium ions therebetween. The separator 330 may be made of, for example, a polyethylene film, a polypropylene film, a polyethylene-polypropylene film, or the like.

The case 200 accommodates the electrode assembly 300 and, together with the cap assembly 400, forms the external appearance of the secondary battery. The case 200 may have a substantially cylindrical body portion and a bottom portion connected to one side (e.g., to one end) of the body portion. The case 200 may be made of a metal, such as aluminum, aluminum alloy, or nickel-plated steel, a laminated film, or plastic (e.g., in a pouch-type embodiment). The second lead tab 321 may be attached and electrically connected to the bottom of the case 200.

The cap assembly 400 may include a cap plate 410 having an insertion hole 411 provided therein, a terminal plate 420 including an insertion portion 421 disposed on the cap plate 410 and inserted into the insertion hole 411, and an insulator 430 disposed between the cap plate 410 and the terminal plate 420.

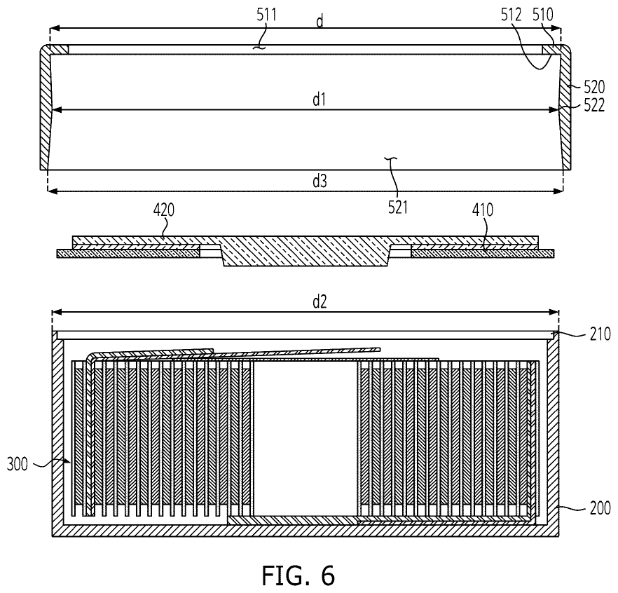

For example, the cap plate 410 may have the shape of a disk having an insertion hole 411 provided at the center, e.g., the cap plate 410 may have an annular shape. The cap plate 410 may be provided to have a larger diameter than either the terminal plate 420 or the insulator 430. The cap plate 410 may be inserted into and disposed in a fastening recess 210 (FIG. 6) recessed in the upper end of the case 200 to close an opening of the case 200. In another example, the shape of the cap plate 410 may be any shape corresponding to the shape of the case to which the cap plate 410 is fastened.

For example, the terminal plate 420 may be provided in the shape of a disk having a smaller diameter than the cap plate 410, and may have the insertion portion 421 provided in the central portion to be inserted into the insertion hole 411 of the cap plate 410. For example, referring to FIG. 3, the terminal plate 420 may include a body portion 422 having the shape of a disk, and the insertion portion 421 extending (e.g., protruding) from the center of the body portion 422. The insertion portion 421 may be provided to protrude outward from the cap plate 410 while inserted in the insertion hole 411, e.g., the insertion portion 421 may protrude toward the electrode assembly 300 while inserted in the insertion hole 411. The insertion portion 421 described above may have a configuration to which the first lead tab 311 is attached. In another example, the terminal plate 420 may have a variety of shapes corresponding to the shape of the cap plate 410. In this manner, the first lead tab 311 is attached to the insertion portion 421 and the second lead tab 321 is attached to the case 200, such that the terminal plate 420 may function as the positive electrode and the case 200 may function as the negative electrode.

The insulator 430 may be disposed between the cap plate 410 and the terminal plate 420 to electrically insulate between the cap plate 410 and the terminal plate 420. Because the cap plate 410 and the terminal plate 420 are made of a conductive metal material and electrically connected to the second lead tab 321 functioning as a negative electrode and the first lead tab 311 functioning as a positive electrode, respectively, the insulator 430 may insulate between the cap plate 410 and the terminal plate 420, thereby preventing a short circuit from occurring. The insulator 430 described above may be made of a resin, such as polypropylene (PP) or polyethylene (PE).

Similar to the cap plate 410, the insulator 430 may be provided in the shape of a disk having an insertion hole 431 formed in the central portion. Accordingly, the insertion portion 421 of the terminal plate 420 may be disposed to penetrate the insertion hole 431 of the insulator 430 and the insertion hole 411 of the cap plate 410 such that the first lead tab 311 is attached to the insertion portion 421. The size of the outer diameter of the insulator 430 may be the same as or similar to the size of the outer diameter of the terminal plate 420. The cap plate 410 may be formed to have an outer diameter larger than an outer diameter of either the insulator 430 or the terminal plate 420. In addition, the size of the diameter of the insertion hole 431 of the insulator 430 may be the same as or similar to the size of the diameter of the insertion hole 411 of the cap plate 410.

The insulator 430 may be attached to the cap plate 410 and the terminal plate 420 by a thermal fusion method of heating and pressing the cap plate 410 and the terminal plate 420 in a state in which the insulator 430 is disposed between the cap plate 410 and the terminal plate 420.

An insulating washer may be disposed between the cap plate 410 and the first lead tab 311 to insulate between the cap plate 410 and the first lead tab 311. In addition, referring to FIG. 2, an insulating sheet 340 may be disposed on the upper portion the electrode assembly 300 to insulate between the upper portion of the electrode assembly 300 and the first lead tab 311.

For example, referring to FIGS. 1-3, the secondary battery 100 may be a coin or a button battery. In another example, the present disclosure may be applied to other types of secondary batteries (e.g., cylindrical batteries). For example, although FIG. 3 shows the first lead tab 311 protruding upward and connected to the insertion portion 421 of the cap plate 410 and the second lead tab 321 protruding downward and connected to the case 200, both the first lead tab and the second lead tab may be configured to protrude upward (e.g., in a same direction) and be connected to the cap assembly and the case, respectively.

The spacer 500 may have the terminal opening 511 provided therein. The spacer 500 may be fitted to an outer portion of the case 200. The spacer 500 may expose a portion of the terminal plate 420 through the terminal opening 511 (FIG. 1). For example, the body portion 422 of the terminal plate 420 may be exposed through the terminal opening 511. The body portion 422 of the terminal plate 420 may be positioned in the terminal opening 511.

The spacer 500 may include a pressing portion 510 configured to be pressed in a case of being coupled to the case 200 and a coupling portion 520 extending perpendicularly from an outer end of the pressing portion 510 and positioned on a side of the case 200. The coupling portion 520 may be configured to have different thicknesses depending on the position in the longitudinal direction. For example, referring to FIG. 3, the pressing portion 510 may be parallel to the bottom of the case 200 and to the body portion 422, and the coupling portion 520 may extend from the pressing portion 510 along an outer sidewall of the case 200, e.g., the pressing portion 510 with the coupling portion 520 may be integral with each other and configured to have a combined cross-section of an inverted L extending from an upper edge of the case 200.

With the cap assembly 400 and the case 200 coupled (e.g., via insertion of the cap plate 410 into the fastening recess of the case 200 to have uppermost surfaces of the cap plate 410 and the case 200 coplanar and level with each other), the spacer 500 may be fitted to the outer portions of the cap assembly 400 and the case 200. The spacer 500 may be fitted to the outer portion of the case 200 and may contact the cap assembly 400. For example, referring to FIG. 3, the pressing portion 510 of the spacer 500 may be positioned to overlap (e.g., and directly contact) the uppermost surface of the case 200 and a portion of the uppermost surface of the cap plate 410, and the coupling portion 520 may extend from the pressing portion 510 along an outer surface of the sidewall of the case 200.

In detail, the inner surface of the pressing portion 510 may be in close contact (e.g., direct contact) with the outer circumferential surface (e.g., peripheral upper surface facing away from the electrode assembly 300) of the cap plate 410. With the cap plate 410 in close contact with the inner surface of the pressing portion 510, the terminal plate 420 may be exposed to the outside while inserted into the terminal opening 511 of the spacer 500. In this case, the spacer 500 may be configured such that the diameter of the terminal opening 511 is larger than the diameter of the body portion 422 of the terminal plate 420 such that the spacer 500 does not contact the terminal plate 420. Because the spacer 500 is in contact with the case 200 and the cap plate 410, and thus may function as the negative electrode, and the terminal plate 420 may function as the positive electrode, the spacer 500 may be provided so as not to contact the terminal plate 420, thereby preventing a short circuit from occurring. The spacer 500 may be made of an insulating material, such as plastic, for electrical insulation.

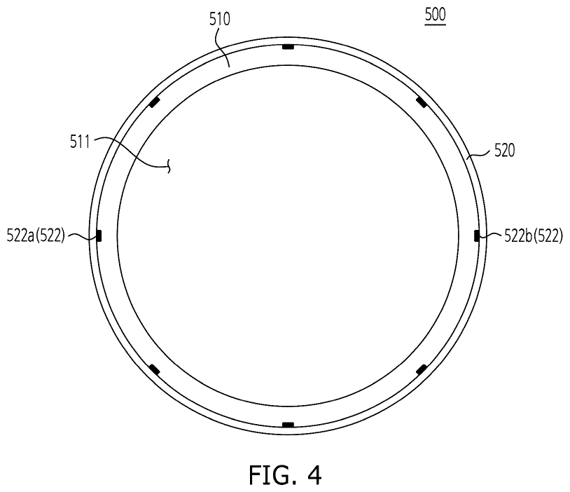

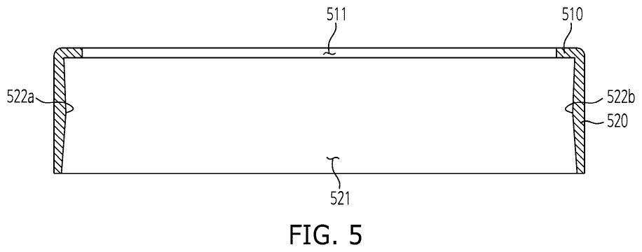

FIG. 4 illustrates a bottom view showing a spacer according to embodiments of the present disclosure. FIG. 5 illustrates a cross-sectional view showing the spacer according to embodiments of the present disclosure. FIG. 6 illustrates an exploded cross-sectional view showing the secondary battery according to embodiments of the present disclosure.

Referring to FIGS. 4-6, the spacer 500 according to embodiments of the present disclosure may include the pressing portion 510, the terminal opening 511 in which the pressing portion 510 is provided, the coupling portion 520 bent from the pressing portion 510, and a coupling opening 521 in which the coupling portion 520 is provided. The spacer 500 may include an elastic material so as to be elastically deformed (e.g., elastically deformable). For example, the spacer 500 may be formed from a polyethylene (PE) resin. The coupling portion 520 may be bent from the pressing portion 510. The coupling portion 520 may be bent perpendicularly and extend from the pressing portion 510.

The pressing portion 510 may form (e.g., define) the terminal opening 511. A portion of the cap assembly 400 may be exposed through the terminal opening 511. The diameter of the terminal opening 511 may be greater than or equal to the diameter of the body portion 422 of the terminal plate 420. A portion of the terminal plate 420 may be positioned inside the terminal opening 511. The terminal plate 420 may be exposed through the terminal opening 511, such that the secondary battery of the present disclosure may be electrically connected to an external device.

The spacer 500 may include protrusions 522 protruding from the inner circumferential surface. For example, the protrusions 522 may be provided on the inner circumferential surface of the coupling portion 520 and may protrude in a direction oriented toward the center of the spacer 500. The coupling portion 520 may include the protrusions 522 protruding from the inner circumferential surface. The protrusions 522 may protrude from the inner circumferential surface at different lengths. In an example, the protrusions 522 may include a longest portion protruding from the inner circumferential surface. That is, the protrusions 522 may have a pointed shape (e.g., an edge of the pointed shape may face the center of the spacer 500). The protrusions 522 may be in close contact (e.g., direct contact) with side surfaces of the case 200 to fix the spacer 500 to the case 200. The protrusions 522 may include a first protrusion 522a and a second protrusion 522b protruding in a direction facing each other. The first protrusion 522a and the second protrusion 522b may be in close contact (e.g., direct contact) with opposite side surfaces of the case 200 to maintain engagement between the spacer 500 and the case 200. For example, each of the first protrusion 522a and the second protrusion 522b may include a plurality of sub-protrusions, e.g., three or more sub-protrusions, so the plurality of sib-protrusions may be spaced apart from each other along the inner circumferential surface of the coupling portion 520.

The spacer 500 may include an insertion opening 521 opposite the terminal opening 511 allowing a portion of the case 200 to be inserted (e.g., insertable) thereinto. The case 200 may be inserted into the insertion opening 521 in a state in which the cap assembly 400 and the case 200 are coupled. A first end of the coupling portion 520 may be perpendicularly connected to the pressing portion 510, and a second end of the coupling portion 520 may form (e.g., define) the insertion opening 521. The diameter of the insertion opening 521 may be formed equal to or greater than the diameter of the case 200. For example, the diameter of the insertion opening 521 may be equal to or greater than the diameter of the outer circumferential surface of the case 200.

Referring to FIG. 6, the case 200 may be inserted into the spacer 500 through the insertion opening 521. The region between the first protrusion 522a and the second protrusion 522b may have a first diameter d1. The first diameter d1 may be a distance between points of the first protrusion 522a and the second protrusion 522b that protrude most from the coupling portion 520. The outer circumferential surface of the case 200 may have a second diameter d2. The first diameter d1 may be smaller than the second diameter d2. The insertion opening 521 may have a third diameter d3. The third diameter d3 may be greater than the second diameter d2 of the outer circumferential surface of the case 200, thereby facilitating the insertion of the case 200 into the insertion opening 521 of the spacer 500. For example, referring to FIG. 3, when the spacer 500 is coupled to the outer portion of the case 200, the inner surface of the bottom portion of the coupling portion 520 that faces the case 200 (e.g., at the insertion opening 521) may not contact the case 200.

As the case 200 is inserted into the spacer 500, the outer circumferential surface of the case 200 may interfere with (e.g., contact) the first protrusion 522a and the second protrusion 522b, because the second diameter d2 is greater than the first diameter d1. In a case where a predetermined pressure is applied to insert the case 200 into the spacer 500, the first protrusion 522a and the second protrusion 522b may be elastically deformed in a direction oriented away from each other, allowing the case 200 to be inserted into the spacer 500. On the other hand, because the first protrusion 522a and the second protrusion 522b are provided on portions of the spacer 500, frictional force acting on the spacer 500 while the spacer 500 is coupled to the case 200 may be reduced. That is, the spacer 500 may be easily coupled to the case 200.

The diameter of a portion of the inner circumferential surface of the spacer 500 adjacent to the pressing portion 510 (i.e., diameter d in FIG. 6) may be substantially the same as the second diameter d2 of the outer circumferential surface of the case 200. That is, the diameter d of the portion of the inner circumferential surface of the spacer 500 adjacent to the pressing portion 510 may be greater than the first diameter d1 and smaller than the third diameter d3.

As described above, while the spacer 500 is coupled to the outer portion of the case 200, the first protrusion 522a and the second protrusion 522b may be elastically deformed in a direction oriented away from each other. That is, the first protrusion 522a and the second protrusion 522b may be pressed in a direction oriented away from each other by the outer circumferential surface of the case 200. In a state where the case 200 is coupled with the spacer 500, the first protrusion 522a and the second protrusion 522b may press the case 200 in a direction toward each other. The first protrusion 522a and the second protrusion 522b may be in linear contact with the outer circumferential surface of the case 200. That is, the first protrusion 522a and the second protrusion 522b may press the case 200, thereby preventing the spacer 500 from being dislodged from the case 200.

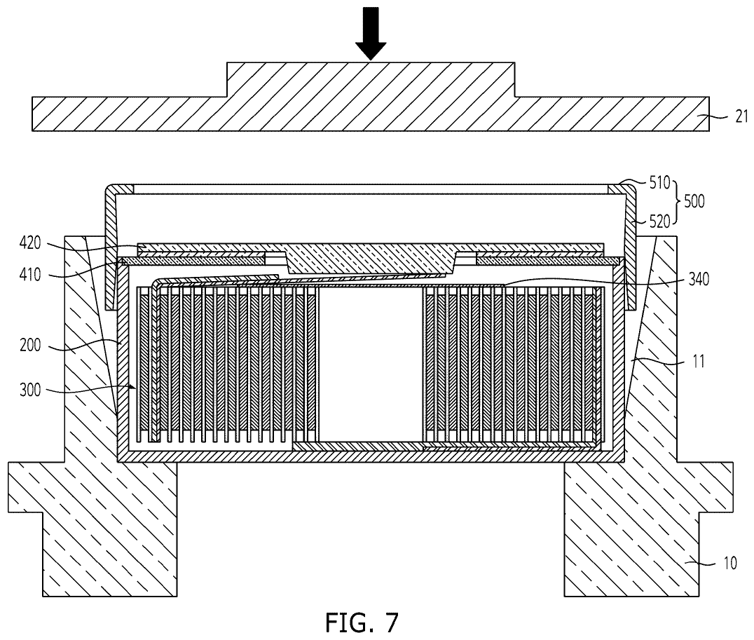

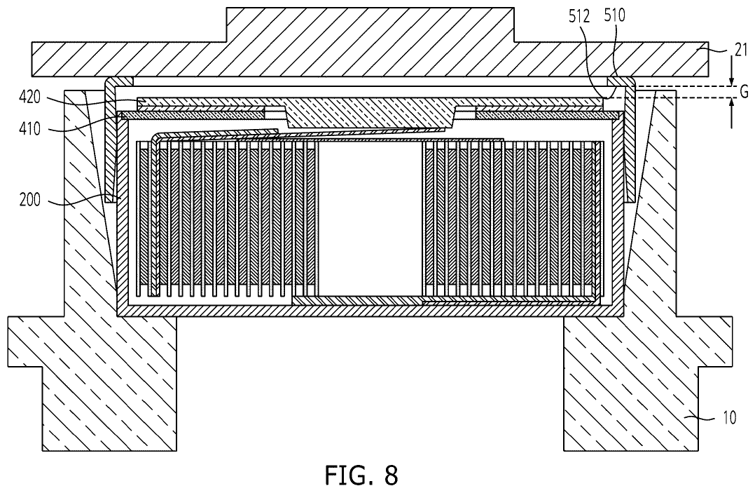

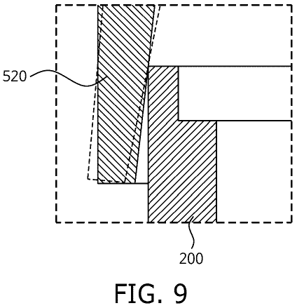

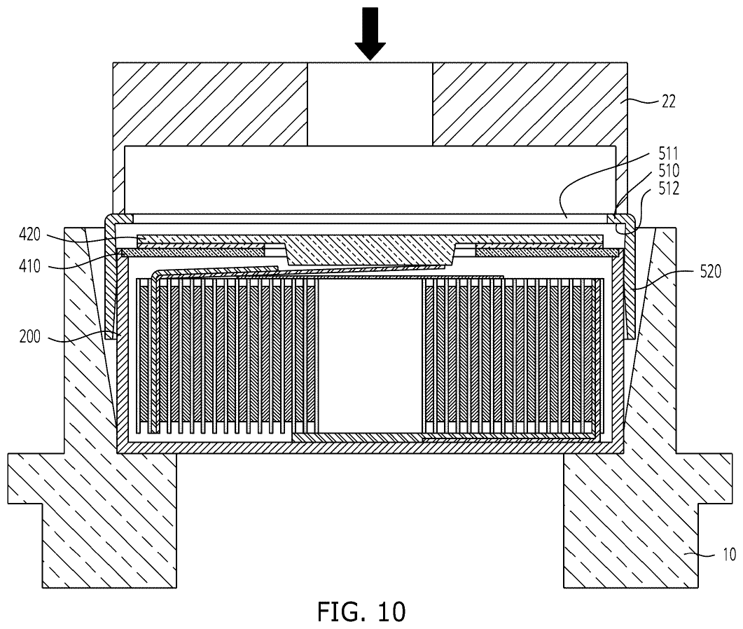

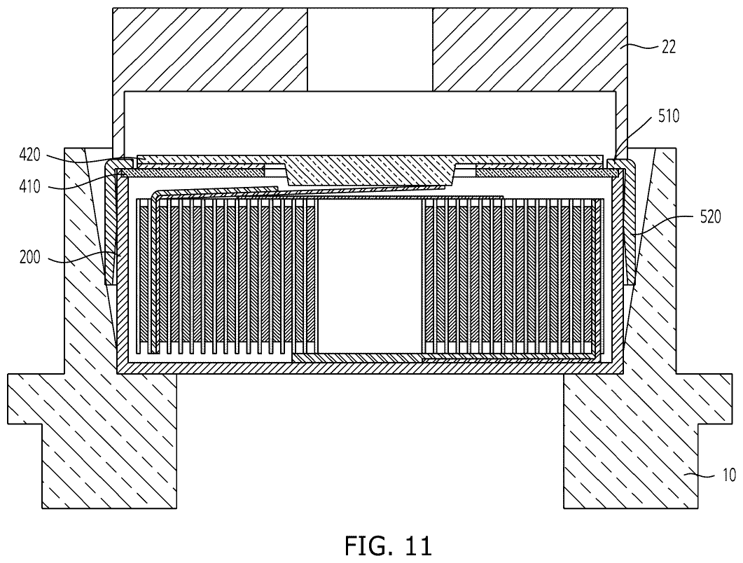

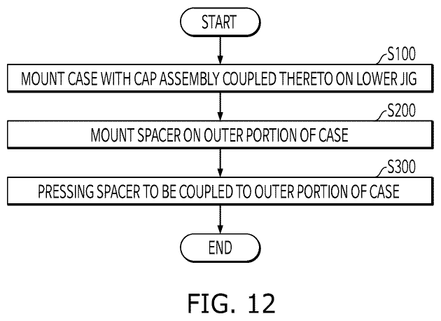

FIG. 7 illustrates a cross-sectional view showing an example of a method of manufacturing a secondary battery according to embodiments. FIG. 8 illustrates a cross-sectional view showing pressing by a first pressing jig in the method of manufacturing a secondary battery according to embodiments. FIG. 9 illustrates a deformed protrusion in the method of manufacturing a secondary battery according to embodiments. FIGS. 10 and 11 illustrate cross-sectional views showing pressing by a second pressing jig in the method of manufacturing a secondary battery according to embodiments. FIG. 12 illustrates a flowchart showing the method of manufacturing a secondary battery according to embodiments.

Referring now to FIG. 12, a method of manufacturing a secondary battery according to embodiments may include mounting a case with a cap assembly coupled thereto on a lower jig (S100), mounting a spacer on an outer portion of the case (S200), and pressing the spacer so that the spacer is coupled to the outer portion of the case (S300).

In detail, referring to FIGS. 7 and 12, mounting the case (S100) may include mounting the case 200 with the cap assembly 400 on a lower jig 10 by inserting the case 200 into a receiving groove 11 of the lower jig 10. The receiving groove 11 of the lower jig 10 may be shaped to have a downward slope, and the diameter of the lower end may be set to be equal to or similar to the diameter of the outer circumferential surface of the case 200. With this configuration, in a case where the case 200 is inserted into the receiving groove 11, a portion of the lower portion of the case 200 may be inserted into the lower end of the receiving groove 11 and fixed so as not to wobble.

Mounting the spacer (S200) may include mounting the spacer 500 on the upper portion of the case 200 inserted into the receiving groove 11 of the lower jig 10. At this time, as shown in FIG. 7, the upper end of the case 200 may be inserted into the insertion opening 521 of the spacer 500, e.g., the case 200 may be inserted to contact the protrusions on the inner surface of the coupling portion 520.

Referring to FIGS. 7, 8, and 12, pressing the spacer (S300) may include pressing the spacer 500 mounted on the upper end of the case 200 to couple the spacer 500 to the case 200. Pressing the spacer 500 may include pressing the upper surface of the spacer 500 with a first pressing jig 21 until the spacer 500 and the cap assembly 400 have a predetermined gap G therebetween, followed by additional pressing until the pressing portion 510 of the spacer 500 is mounted on (e.g., directly contacts) the upper portion of the case 200. That is, pressing the spacer (S300) may be divided into a first pressing (i.e., pressing until the spacer 500 and the cap assembly 400 have the predetermined gap G therebetween) and a second pressing (i.e., pressing until the spacer 500 is mounted on the upper portion of the case 200).

In an embodiment, the first pressing (i.e., pressing the upper surface of the spacer 500) may include pressing the upper surface of the spacer 500 until an inner surface 512 of the spacer 500 and the upper surface of the cap assembly 400 have a gap G of 0.5 mm to 2.0 mm. Because the step of pressing the upper surface of the spacer 500 requires application of a relatively large force so that the upper end of the case 200 is deformed in a direction oriented away from the protrusion 522 of the spacer 500, the first pressing jig 21 may be configured to press the front portion of the top surface of the spacer 500. In a case where the first pressing jig 21 presses the spacer 500, as shown in FIG. 9, the coupling portion 520 may be pressed by the case 200 and be deformed elastically outwardly to guide the insertion of the case 200. In FIG. 9, the dashed portion is shown in an outwardly elastically deformed state.

In an embodiment, the first pressing jig 21 may have the shape of a disk. Because the cap assembly 400 may break in a case where the first pressing jig 21 contacts the terminal plate 420, the first pressing jig 21 may insert the spacer 500 by pressing until the inner surface 512 of the spacer 500 and the upper surface of the cap assembly 400 have a gap G of 0.5 mm to 2.0 mm.

The second pressing (i.e., pressing the pressing portion 510 of the spacer 500) may include pressing the pressing portion 510 of the spacer 500 to bring the cap assembly 400 into close contact with the case 200. A second pressing jig 22 (FIG. 10) configured to press the pressing portion 510 may be provided in a cylindrical shape with a cavity, the diameter of which is at least equal to or greater than the diameter of the terminal opening 511 of the spacer 500. In a case where the pressing portion 510 is pressed using the second pressing jig 22, as shown in FIG. 11, the second pressing jig 22 may press the pressing portion 510 to closely contact the cap assembly 400 without contacting the terminal plate 420 because the cavity of the second pressing jig 22 communicates with the terminal opening 511 of the spacer 500. Accordingly, the spacer 500 may be inserted into and coupled to the case 200 while preventing the cap assembly 400 from breaking.

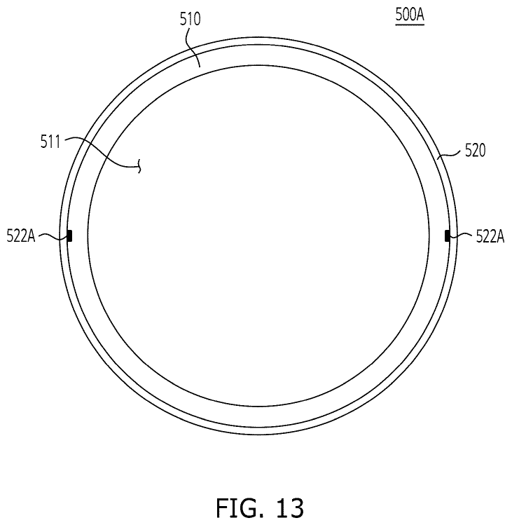

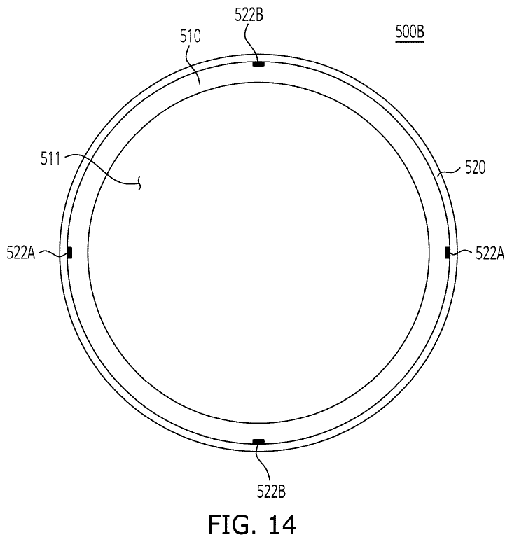

FIGS. 13 and 14 illustrate bottom views showing spacers of a secondary battery according to embodiments of the present disclosure.

Referring to FIG. 13, a spacer 500A according to embodiments of the present disclosure may include the pressing portion 510, the terminal opening 511 defined by the pressing portion 510, the coupling portion 520 bent from the pressing portion 510, and protrusions 522A provided on the inner circumferential surface of the spacer 500A.

A plurality of protrusions 522A may be arranged along the inner circumferential surface of spacer 500A. The protrusions 522A may be arranged to face each other. In an example, the protrusions 522A may be arranged to face each other in a horizontal direction. In addition, the protrusions 522A may be provided as a pair of protrusions facing each other. In this manner, two protrusions 522A (e.g., only two protrusions 522A) may be arranged at 180° to each other on the inner circumferential surface of the spacer 500A.

Referring to FIG. 14, a spacer 500B according to embodiments of the present disclosure may include the pressing portion 510, the terminal opening 511 defined by the pressing portion 510, the coupling portion 520 bent from the pressing portion 510, and protrusions 522 provided the inner circumferential surface of the spacer 500B.

A plurality of protrusions 522 may be arranged along the inner circumferential surface of spacer 500B. The protrusions 522 may be provided as a pair of protrusions facing each other. In an example, the protrusions 522 may include a pair of protrusions 522A arranged to face each other in a horizontal direction and a pair of protrusions 522B arranged to face each other in a vertical direction (as viewed in a plan view of FIG. 14). In this manner, the protrusions 522A and 522B may be provided in four and arranged at 900 to each other on the inner circumferential surface of the spacer 500A.

As described above, in the spacers 500A and 500B according to embodiments of the present disclosure, the protrusions are provided only on a portion of the inner circumferential surface, and therefore the contact area with the case, frictional force, and the like may be reduced. That is, the spacers 500A and 500B according to embodiments of the present disclosure may be easily coupled to the outer portion of the case, and may prevent the case from breaking.

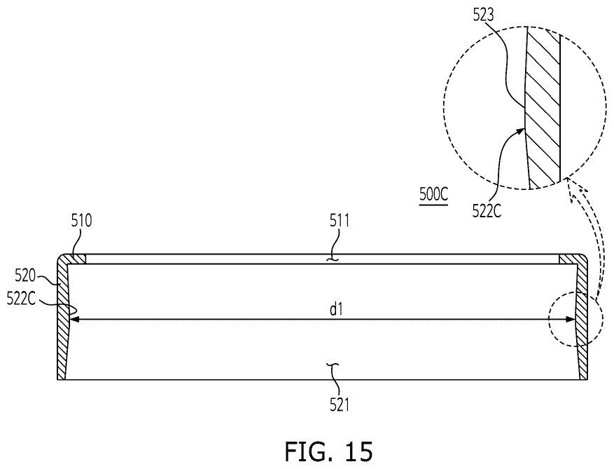

FIG. 15 illustrates a cross-sectional view showing a spacer according to embodiments of the present disclosure.

Referring to FIG. 15, a spacer 500C according to embodiments of the present disclosure may include the pressing portion 510, the terminal opening 511 defined by the pressing portion 510, the coupling portion 520 bent from the pressing portion 510, and the coupling opening 521 defined by the coupling portion 520.

The coupling portion 520 may include protrusions 522C protruding from the inner circumferential surface. Each of the protrusions 522C may include a straight portion 523 of a constant length protruding from the inner circumferential surface. The length of the straight portion 523 protruding from the inner circumferential surface may be the longest. The straight portion 523 may extend such that the protruding length is constant.

In a state where the case 200 is coupled to the spacer 500C, the protrusions 522C may press the case 200 in a direction toward each other. Each of the protrusions 522C may be in surface contact with an outer circumferential surface of the case 200. The spacer 500C of the present disclosure may have an increased contact area with the outer circumferential surface of the case 200, which may improve the strength of the bond between the spacer 500C and the case 200.

Each region between the protrusions 522C may have the first diameter d1. The first diameter d1 may be a distance between straight portions 523 of the protrusions 522C. In embodiments of the present disclosure, the protrusions 522C may be provided in various numbers, such as two, four, or six.

By way of summation and review, in order to fit secondary batteries into slots of different sizes, spacers may be bonded to cases of the secondary batteries. In the process of bonding the spacers, it is necessary to facilitate the bonding to avoid defects, e.g., breakage, of the secondary batteries.

Therefore, the present disclosure provides a secondary battery and a method of manufacturing the same, where the spacer may be easily fastened to the case. According to some embodiments of the present disclosure, the spacer may prevent breakage or deformation of the case when coupled to the case. According to some embodiments of the present disclosure, the spacer may reduce pressure or friction force applied to the case when coupled to the case.

However, aspects and features of the present disclosure are not limited to those described above, and other aspects and features not mentioned will be clearly understood by a person skilled in the art from the detailed description, described above.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure and the claims and their equivalents, below.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A secondary battery, comprising:
an electrode assembly including a first electrode and a second electrode;
a case including a first side that is open, the case accommodating the electrode assembly and being electrically connected to the second electrode;
a cap assembly coupled to the first side of the case, the cap assembly being electrically connected to the first electrode; and
a spacer coupled to an outer portion of the case and contacting the cap assembly, the spacer including a first protrusion and a second protrusion opposite the first protrusion, the first protrusion and the second protrusion contacting the case.

2. The secondary battery as claimed in claim 1, wherein:
the spacer further includes a terminal opening exposing at least a portion of the cap assembly, and an insertion opening opposite the terminal opening, portions of the cap assembly and the case being insertable into the insertion opening, and
each of the first protrusion and the second protrusion protrudes from an inner circumferential surface of the spacer.

3. The secondary battery as claimed in claim 2, wherein:
a region between the first protrusion and the second protrusion has a first diameter, and
the case has a cylindrical shape having an outer circumferential surface having a second diameter greater than the first diameter.

4. The secondary battery as claimed in claim 3, wherein the insertion opening of the spacer has a third diameter greater than the second diameter.

5. The secondary battery as claimed in claim 2, wherein the cap assembly includes a terminal plate having a disk-shaped body portion and an insertion portion protruding from the body portion, a diameter of the terminal opening being greater than a diameter of the body portion.

6. The secondary battery as claimed in claim 1, wherein the first protrusion and the second protrusion include a plurality of first sub-protrusions and a plurality of second sub-protrusions, respectively, the plurality of first sub-protrusions being spaced apart from each other by a predetermined gap, and the plurality of second sub-protrusions being spaced part from each other by the predetermined gap.

7. The secondary battery as claimed in claim 1, wherein each of the first protrusion and the second protrusion includes a straight portion in surface contact with the case.

8. The secondary battery as claimed in claim 1, wherein the spacer includes an elastic material.

9. The secondary battery as claimed in claim 8, wherein, while the spacer is coupled to the outer portion of the case, the first protrusion and the second protrusion are elastically deformable in a direction oriented away from each other.

10. The secondary battery as claimed in claim 9, wherein, in a state where the spacer is coupled to the outer portion of the case, the first protrusion and the second protrusion press the case.

11. A secondary battery, comprising:
an electrode assembly including a first electrode and a second electrode;
a cylindrical case including a first side that is open, the case accommodating the electrode assembly and being electrically connected to the second electrode;
a cap assembly coupled to the first side of the case, the cap assembly including a terminal plate electrically connected to the first electrode; and
a spacer contacting the cap assembly and including a first protrusion and a second protrusion opposite the first protrusion, the first protrusion and the second protrusion contacting an outer portion of the case,
wherein, while the spacer is coupled to the outer portion of the case, the first protrusion and the second protrusion are elastically deformable in a direction oriented away from each other, and in a state where the spacer is coupled to the outer portion of the case, the first protrusion and the second protrusion press the case in a direction oriented toward each other.

12. The secondary battery as claimed in claim 11, wherein the first protrusion and the second protrusion protrude from an inner circumferential surface of the spacer in a direction facing each other.

13. The secondary battery as claimed in claim 11, wherein the spacer includes:
a coupling portion outside the case;
a pressing portion contacting the cap assembly;
a terminal opening defined by the pressing portion to expose at least a portion of the cap assembly, a portion of the terminal plate being positioned inside the terminal opening; and
an insertion opening defined by the coupling portion, a portion of the case being inserted through the insertion opening.

14. The secondary battery as claimed in claim 13, wherein:
a region between the first protrusion and the second protrusion has a first diameter,
an outer circumferential surface of the case has a second diameter greater than the first diameter, and
the insertion opening of the spacer has a third diameter greater than the second diameter.

15. A method of manufacturing a secondary battery, the method comprising:
mounting a case on a lower jig, the case having an electrode assembly and a cap assembly accommodated therein, the electrode assembly including a first electrode electrically connected to the cap assembly and a second electrode electrically connected to the case;
mounting a spacer on an outer portion of the case, the spacer including a first protrusion and a second protrusion opposite the first protrusion; and
pressing the spacer onto the case so that the spacer is interference-fitted into the case with the cap assembly contacting the case and the first and second protrusions contacting the case.

16. The method as claimed in claim 15, wherein pressing the spacer includes:
pressing the spacer using a first pressing jig until the spacer and the cap assembly have a predetermined gap therebetween; and
pressing the spacer using a second pressing jig until the spacer is mounted on an upper portion of the case.

17. The method as claimed in claim 16, wherein pressing the spacer includes pressing the spacer until the predetermined gap between the spacer and an upper surface of the cap assembly is 0.5 mm to 2.0 mm.

18. The method as claimed in claim 15, wherein the spacer further includes:
a pressing portion including a terminal opening, the pressing portion being mounted on an upper portion of the case; and
a coupling portion extending perpendicularly from an outer end of the pressing portion, the first protrusion and the second protrusion protruding from an inner circumferential surface of the coupling portion and contacting the case.

19. The method as claimed in claim 18, wherein pressing the spacer includes pressing the pressing portion into close contact with the cap assembly so that a portion of the cap assembly is positioned inside the terminal opening.

20. The method as claimed in claim 15, wherein, while the spacer is coupled to an outer portion of the case, the first protrusion and the second protrusion are elastically deformed in a direction oriented away from each other.
